(19) United States
(12) Patent Application Publication
(10) Pub. No.: US 2022/0400320 A1
(43) Pub. Date: Dec. 15, 2022

(54) MOBILE OCEAN EXPLORATION PLATFORM

(71) Applicants: Andrew Bennett, Belmont, MA (US); David Barrett, Needham, MA (US)

(72) Inventors: Andrew Bennett, Belmont, MA (US); David Barrett, Needham, MA (US)

(21) Appl. No.: 17/347,254

(22) Filed: Jun. 14, 2021

(51) Int. Cl. H04Q 9/00; G01P 5/00; B63B 22/20

(52) U.S. Cl. CPC H04Q 9/00; G01P 5/00; B63B 22/20; B63B 2211/02

(57) ABSTRACT

This invention is an apparatus that can be intermittently bottom moored and moved with buoyancy as it uses its sensors to collect data in deep ocean water. In one embodiment of the invention, the apparatus includes one or more floats, buoyancy engines, payload sensors, depth sensors and electronics. The electronics provide the power and, among other things, control the transmission of data from and the reception of information by the apparatus. An anchor is used to moor the apparatus at desired locations. When not moored, the apparatus drifts with the currents at the depth at which the apparatus is then positioned, with the movement being directed by current flow of the water. The movement of the apparatus is guided with knowledge of the currents and tides (it is not random).

### FIELD OF INVENTION

The invention relates generally to an apparatus that can be alternatively and as needed moored at the bottom of the ocean or drift to sense and collect data, with the data periodically transmitted to a distal receiving location.

### COPYRIGHT NOTICE

A portion of the disclosure of this patent application contains material that is subject to copyright protection. Noting the confidential protection afforded non-provisional patent applications prior to publication, the copyright owner hereby authorizes the U.S. Patent and Trademark Office to reproduce this document and portions thereof prior to publication as necessary for its records. The copyright owner otherwise reserves all copyright rights whatsoever.

### BACKGROUND

Large areas of the oceans, especially the deeper, offshore, ocean regions, remain heavily underexplored. Accordingly, much of the world's oceans are poorly understood due a lack of data about these regions. This deficiency results in significant gaps in the basic environmental data needed to manage and protect the areas, to forecast the impact of environmental changes on the areas, and to facilitate sustainable economic development within the associated coastal waters. This lack of deep-water, offshore data is primarily driven by the lack of cost-effective ways to collect it. Data collection is a difficult, expensive process, largely due to the most common data collection system being ships, which are very expensive to operate. Collection platforms, such as autonomous oceanic gliders, sometimes referred to at Slocum Gliders, use buoyancy changes to move through the water column much like an atmospheric glider uses lift and gravity to propel itself forward, but these collection platforms are not optimal in operation or in cost-efficiency.

While there is a growing set of cost-effective surface and near surface tools, like satellite data and low-cost drifting buoys, collecting data at or below two hundred (200) meters has been regarded in the past as the domain of expensive surface ships, towed arrays, manned submersibles, fixed moorings, complex unmanned undersea vehicles, or combinations of the foregoing. Although there have been low-cost surface drifting buoys in use for years, there have been no devices that can be used for large scale strategic data collection and exploration.

### SUMMARY

The present invention intends to increase the scope and efficiency of acquiring ocean exploration data, primarily in water depths of two hundred (200) meters or deeper. Tidal and other flow rates and direction in the ocean vary by depth and location, and the present invention uses this knowledge to optimize its operations, changing its depth to autonomously bias its drift over time to propel itself along a desired direction. The inventive apparatus is a relatively low-cost, bottom hopping drifting vehicle that can use deep-water bottom currents to cover hundred long mile transits, while pausing and autonomously anchoring at discrete locations to collect both spatial and temporal data. The apparatus, in one of its more general foul's, comprises at least one surface recovery float and at least one sub-surface float. Both forms of floats are connected a frame. The frame houses elements such as, for example, at least one buoyancy engine, at least one payload sensor, at least one depth sensor, and electronics that control the apparatus. The electronics include, for example, a transmitter/receiver and a power source. Further, buoyancy engine(s), payload sensor(s), and depth sensor are electronically connected to the electronics. The apparatus also has an anchor, connected to the frame. In operation, the apparatus is intermittently bottom moored and moved with buoyancy as it drifts with the currents at the depth at which the apparatus is then positioned, and the timing of the mooring and the movement is variable.

### BRIEF DESCRIPTION OF THE FIGURES

FIG. 1 shows a side view of one embodiment of the present invention.

FIG. 2 shows the possible positionings of an embodiment of the present invention in four distinct locations as it moves with the bottom current, with one of the locations being on the ocean floor.

### DETAILED DESCRIPTION

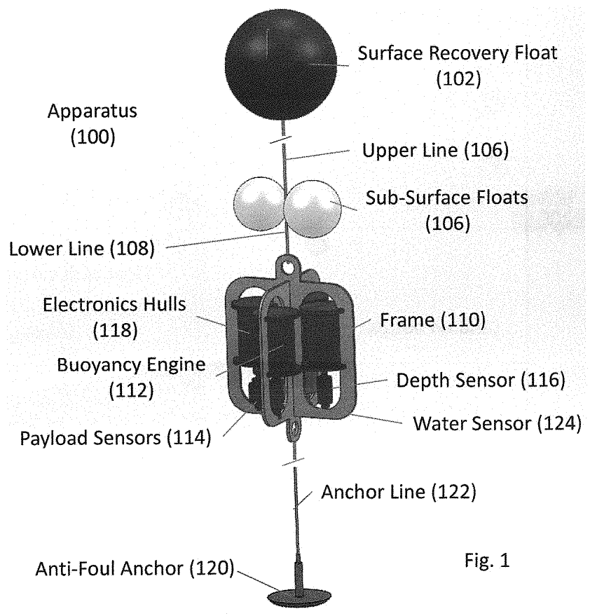

FIG. 1 shows one embodiment of the present invention apparatus 100. In this particular embodiment, there is single surface recovery float 102. One of ordinary skill in the art would realize that there can be multiple elements in the construction or use of surface recovery float 102 and that other elements can be used to serve the same operational purpose. The other elements of apparatus 100 are connect to surface recovery float 102 through steel line 104. One of ordinary skill in the art would understand that other connectors can serve the same function as steel line 104, with the length and/or the material being selected with the expected use conditions and the cost of the connector in mind.

In the embodiment of the present invention depicted in FIG. 1, the end of steel line 104 that is distal from its connection with surface recovery float 102 is connected to sub-surface floats 106. In this particular version of the present invention, there are two elements that comprise sub-surface floats 106. Extending away from sub-surface floats 106, in the direction opposite surface recovery 102, is steel line 108. Like the other steel lines, the length and other characteristics of steel line 108, or its functional equivalents, are variable and can be set based upon the expected use conditions and associated element costs for apparatus 100.

In the use of apparatus 100, frame 110 is connected to sub-surface floats 106. In the presented configuration, frame 110 is made of low-cost polyvinyl chloride (PVC) material. One of ordinary skill in the art would realize that the materials for and the configuration of the elements for frame 110 can vary. In this particularly depicted version of apparatus 100, frame 110 is configured to hold various other elements of apparatus 100 in four sections of roughly equal dimension.

Within and connected to frame 110 is buoyancy engine 112. Buoyancy engine 112 changes the net buoyancy of the apparatus between negative (sinking), neutral (floating at constant depth) and positive (floating upwards) buoyancy as required for operation. One of ordinary skill would know and understand the functional equivalents to the engine disclosed herein.

Also housed within and secured to frame 110 are payload sensors 114. Payload sensors 114 collect data about the environment for the purposes of the science mission(s) for which apparatus 100 is being used and can be replaced with different sensors for different missions. As such, the number, exact positioning, types and characteristics of the sensors are dictated by the nature and demands of the mission(s).

At least one depth sensor 116 is positioned within and affixed to frame 110. Depth sensor 116 senses the current depth of apparatus 100, which is necessary to monitor whether the vehicle buoyancy change has resulted in the desired positive/neutral/negative change commanded. Other instrumentality may also be utilized with or instead of depth sensor 116 provided the combination or substitute(s) provide similar data for controlling the depth of apparatus 100.

In certain embodiments of the present invention, apparatus 100 may also have, attached to and within frame 110, water sensor 124. In the embodiments that include water sensor 124, apparatus 100 can sense the motion of the water at a distance from apparatus 100 and can then signal for the changes in the depth. These changes cause apparatus 100 to enter or exit the detected moving water that will affect its motion. Although water sensors 124 provide an additional parameter for the function and operation of apparats 100, they are not essential for its general performance or for apparatus 100 to achieve its intended purposes in novel ways.

Apparatus-controlling electronics 118, also referred to in FIG. 1 as electronics hulls, are within and connected to frame 116 and electronically connected to other elements within and associated with apparatus 100 (such as, for example, and buoyancy engine 112, payload sensors 114, and depth sensor 116). In this embodiment, apparatus-controlling electronics 118 include, for example, a transmitter/receiver and a power source. Additionally, apparatus-controlling electronics 118 and the configuration of frame 110 preferably employ open architectures so they can be highly modular, thus accommodating scientific payload that can carry out multiple exploration missions. Such missions can employ traditional data collection instruments (e.g., temperature, salinity, oxygen, and other sensors) and/or new data collection systems (e.g., fish species detection, bottom imaging collection and acoustic recording). This variability allows multiple embodiments of apparatus 100 carrying different sensor payloads to be deployed in a single mission to capture a wider breadth of environmental data.

In the operational configuration of apparatus 100, anchor 120 is positioned at the bottom of and connected by steel line 122 to frame 110. Both anchor 120 and steel line 122 can be made of materials and configured as determined to be optimal for the operational use of apparatus 100, mindful of the costs of the materials. When apparatus 100 is intermittently bottom moored, anchor 120 is in contact with the ocean floor such that apparatus 100 stays stationary. As such, apparatus 100 is in a heavy benthic state when moored, with the anchor temporarily sitting on the bottom. At times when buoyancy engine 112 is activated to lift apparatus 100 from the ocean floor, apparatus 100 is moved with buoyancy so it can drift with the currents at the depth at which apparatus 100 is then positioned. The bottom mooring can be autonomously fixed at discrete locations.

During specific stages of the operation of certain embodiments of the present invention, the movement of apparatus 100 is in a free-floating nekton state (such as, for example, when apparatus 100 is slightly positively buoyant) such that apparatus 100 rises to a near bottom flight height. At such height, apparatus 100 then drifts with the prevailing currents following current-determined exploration path. A guiding principle of the movement of apparatus 100 is its use of alternatively deep ocean currents and known coastal tidal flows to move.

Thus, the timing of the mooring and the movement are both variable, with the movement accomplished through the flow of deep-water bottom currents. A user of apparatus 100 can pre-set the duration of the time that apparatus 100 is moored for, for example, the total time of the deployment of apparatus 100. Alternatively, maximizing on novelty of the present invention, the duration of the time that apparatus 100 is moored, as opposed to the time it is drifting, is set during the deployment of apparatus 100 through a signal sent to the transmitter 1 receiver.

One of ordinary skill in the art would realize that sensors that collect deep-water, offshore data can be include with apparatus-controlling electronics 118 or be affixed separately to frame 110 while nevertheless electronically connected to one or more elements within apparatus-controlling electronics 118. Accordingly, the electronics can collect both spatial and temporal data. With the collected data, buoyancy engine 112 can cause apparatus 100 to rise to the surface periodically and the transmitter/receiver can upload data via, for example, an existing satellite network link. Further, knowledge of current and tide tables, which can be, for example, pre-loaded into apparatus-controlling electronics 118 or downloaded to apparatus 100 via the transmitter/receiver as or after apparatus 100 rises to the surface, can be used to map the movement of apparatus 100 for its deployment 100 in deep-water exploration, with stops to take samples, over months.

In an example of an operational possibility, apparatus 100 can rise to the surface, for instance, over a preestablished cycle of mooring and drafting, and upload data via an existing satellite network link when apparatus 100 is at or close enough to the water's surface. Unlike a glider, which uses buoyancy changes to propel itself forward and cannot stop in place for temporal measurements (for example, a camera system that captures what pelagic fish exist at that location over a week, or a hydrophone that records what acoustic signatures can be collected in a twenty-four hour cycle), or a typical ARGOS pop-up drifter which moves with the surface currents, apparatus 100 can either stay in place for, for example, a week and, alternatively or also, use a clock, calendar and knowledge of current and tide tables to move along a deep-water exploration survey path, stopping at sample points, over months.

Apparatus 100 can use two fundamental flows to move along a path: deep ocean currents and known coastal tidal flows. Deep ocean currents are driven by density and temperature gradients and cover long strategic ranges. These thermohaline circulation currents can act as a deep-water conveyor belt to move apparatus 100. These currents, also called submarine rivers, flow under the observable surface waters of the ocean and apparatus 100 can potentially ride them for thousands of miles down range. Tidal flow currents in the ocean vary by depth and location but are often orthogonal to the coastline and the underlying deep-water currents. In the open ocean, tidal current effects can be detected at depths as great as four kilometers. By moving deeper for half of a tidal cycle, and moving shallower for the other half, apparatus 100 can be induced into a net cyclic motion along a particular direction, using only buoyancy and depth changes. By exploiting both current modes, apparatus 100 can potentially cover wide survey areas of interest, instead of just following a single linear track. In locations where apparatus 100 can reach the bottom, it can further control its motion by sitting on the ocean floor until such time as the tidal flow is in the desired direction, causing a larger net directional drift.

In keeping with the design principals of the existing fleet of surface low-cost drifters, apparatus 100 is designed to be both relatively low-cost and potentially expendable. The main base-system costs is primarily centered around buoyancy engine 112 and transmitter/receiver for satellite data links.

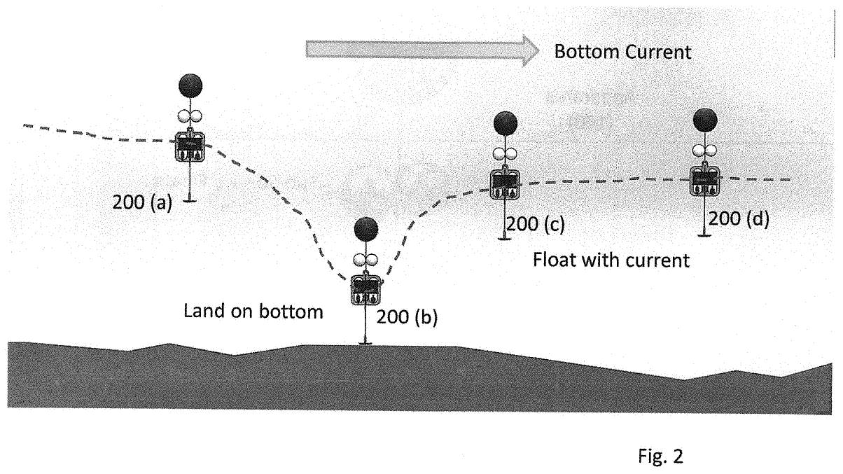

FIG. 2 shows an example of the movement of apparatus 200. Flowing with the bottom current, apparatus 200a is in a ‘drifting’ position above the ocean surface. Apparatus 200b is in a position on the ocean floor (the “land on bottom” location) as directed by the apparatus-controlling electronics onboard and as allowed to descend by the buoyancy engine. Apparatus 200c shows the device in a position after the buoyancy engine has been activated to lift apparatus 200. Finally, apparatus 200d is in a down-current location as apparatus 200 again drifts with the bottom current.

### Additional Thoughts

The foregoing descriptions of the present invention have been provided for the purposes of illustration and description. It is not intended to be exhaustive or to limit the invention to the precise forms disclosed. Many modifications and variations will be apparent to the practitioner of ordinary skilled in the art. Particularly, it would be evident that while the examples described herein illustrate how the inventive apparatus may look and how the inventive process may be performed. Further, other elements and/or steps may be used for and provide benefits to the present invention. The depictions of the present invention as shown in the exhibits are provided for purposes of illustration.

The embodiments were chosen and described in order to best explain the principles of the invention and its practical application, thereby enabling others of ordinary skill in the art to understand the invention for various embodiments and with various modifications that are suited to the particular use contemplated.

What is claimed is:

1. An apparatus comprising:
at least one surface recovery float;
at least one sub-surface float connected to the at least one surface float;
a frame connected to the at least one sub-surface float;
at least one buoyancy engine within and connected to the frame;
at least one payload sensor within and connected to the frame;
at least one depth sensor within and connected to the frame;
apparatus-controlling electronics, within and connected to the frame, wherein such apparatus-controlling electronics includes a transmitter/receiver and a power source and wherein such apparatus-controlling electronics are electrically connected to the at least one buoyancy engine, at least one payload sensor and at least one depth sensor within and connected to the frame; and
an anchor connected to the frame;
wherein the apparatus is intermittently bottom moored and moved with buoyancy as such apparatus drifts with the currents at the depth at which the apparatus is then positioned and the timing of the mooring and the movement is variable.

2. The apparatus of claim 1 further comprising sensors that collect deep-water, offshore data.

3. The apparatus of claim 1 wherein the movement is accomplished through the flow of deep-water bottom currents.

4. The apparatus of claim 3, wherein the movement is in a free-floating nekton state, and further wherein the apparatus is slightly positively buoyant such that the apparatus rises to a near bottom flight height and wherein the apparatus then drifts with the prevailing currents following pre-set exploration path.

5. The apparatus of claim 4 wherein the apparatus uses alternatively deep ocean currents and known coastal tidal flows to move.

6. The apparatus of claim 1 wherein the bottom mooring autonomously fixed at discrete locations.

7. The apparatus of claim 6 wherein the apparatus is in a heavy benthic state when moored, with the anchor temporarily sitting on the bottom.

8. The apparatus of claim 7 a user of the apparatus can pre-set the duration of the time that apparatus is moored for the total time of the deployment of the apparatus.

9. The apparatus of claim 7 the duration of the time that apparatus is moored is set during the deployment of the apparatus through a signal sent to the transmitter/receiver.

10. The apparatus of claim 1, wherein the apparatus further comprises the electronics to collect both spatial and temporal data.

11. The apparatus of claim 10, wherein the buoyancy engine causes the apparatus to rise to the surface periodically and the transmitter/receiver uploads data via an existing satellite network link.

12. The apparatus of claim 11, wherein knowledge of current and tide tables is used to move the apparatus along during the deployment of the apparatus in deep-water exploration, with stops to take samples, over months.

13. The apparatus of claim 1 wherein the apparatus comprises open architecture to be highly modular for scientific payload that could carry out multiple exploration missions.

14. The apparatus of claim 1 further comprising at least one water speed measuring device within and connected to the frame.
